(19) United States
(12) Patent Application Publication
(10) Pub. No.: US 2013/0169438 A1
(43) Pub. Date: Jul. 4, 2013

(54) DEVICE HAVING ALARM SYSTEM BASED ON INFRARED DETECTION AND METHOD FOR INSTALLING ALARM SYSTEM TO A DEVICE

(71) Applicant: WEN-HUI ZHANG, Shenzhen City (CN)

(72) Inventor: WEN-HUI ZHANG, Shenzhen City (CN)

(73) Assignees: HON HAI PRECISION INDUSTRY CO., LTD., Tu-cheng (TW); HONG FU JIN PRECISIO INDUSTRY (ShenZhen) CO., LTD., Shenzhen City (CN)

(21) Appl. No.: 13/400,596

(22) Filed: Feb. 21, 2012

(30) Foreign Application Priority Data
Dec. 29, 2011 (CN) 201110450167.4

(51) Int. Cl. G08B 13/18

(52) U.S. Cl. 340/555

(57) ABSTRACT

A device having an alarm system based on infrared detection includes an exterior casing, an interior casing located in the exterior casing, and an alarm system received in a space cooperatively formed by the exterior and interior casings. The alarm system is configured to detect transgression into the space, and includes a number of pairs of infrared sensors, an alarm nodule, and a control module. Each pair of infrared sensors includes an infrared radiation transmitter configured to emit infrared rays, whereby the space is fillable with infrared rays emitted by all the infrared radiation transmitters; and an infrared radiation receiver configured to receive the infrared rays from the infrared radiation transmitter. The control module is configured to detect any signal generated by an infrared radiation receiver, and actuate the alarm module to generate an alarm signal when at least one infrared radiation receiver has ceased to receive infrared rays.

### BACKGROUND

1. Technical Field

The present disclosure relates to devices having an alarm and, more particularly, to a device having an alarm system and a method for installing the alarm system to a device.

2. Description of Related Art

Infrared alarm systems have been developed for safeguarding certain security devices and the contents thereof. However, the attachment of at least part of the alarm system outside the security device allows unauthorized persons to easily access the alarm system and seek to disable it. Thereby, an unauthorized person may force entry into the security device after disabling the exposed part of the alarm system, thus circumventing the protection.

Therefore, what is needed is a means to solve the problems described above.

### BRIEF DESCRIPTION OF THE DRAWINGS

Many aspects of the present disclosure can be better understood with reference to the following drawings. The elements in the drawings are not necessarily drawn to scale, the emphasis instead being placed upon clearly illustrating the principles of the present disclosure. Moreover, in the drawings, like reference numerals designate corresponding parts throughout the views.

FIG. 1 is a cross-sectional view of a device having an alarm system in accordance with an exemplary embodiment.

FIG. 2 is a block diagram of the alarm system of the device of FIG. 1.

FIG. 3 is a flowchart of a method for installing the alarm system to the device of FIG. 1.

### DETAILED DESCRIPTION

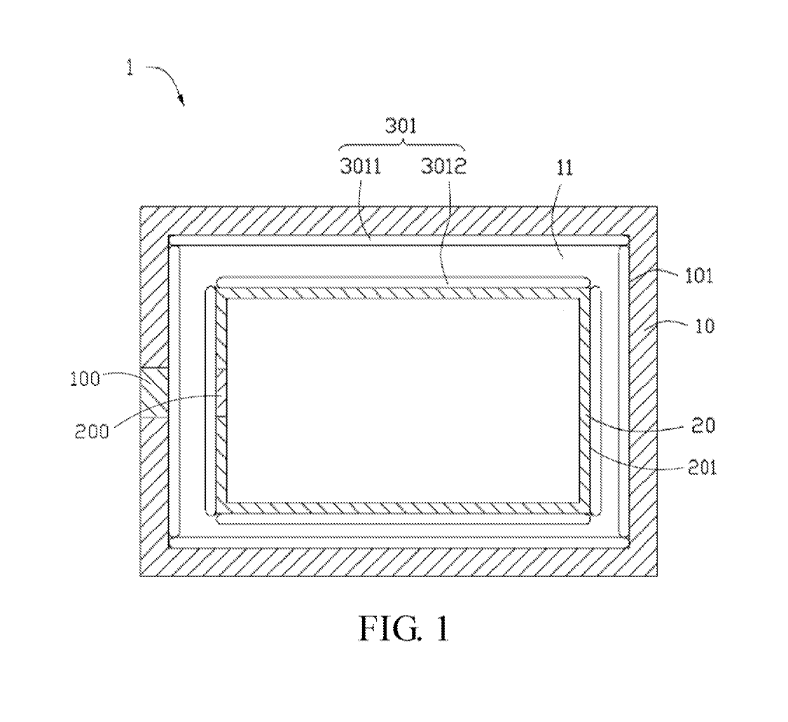

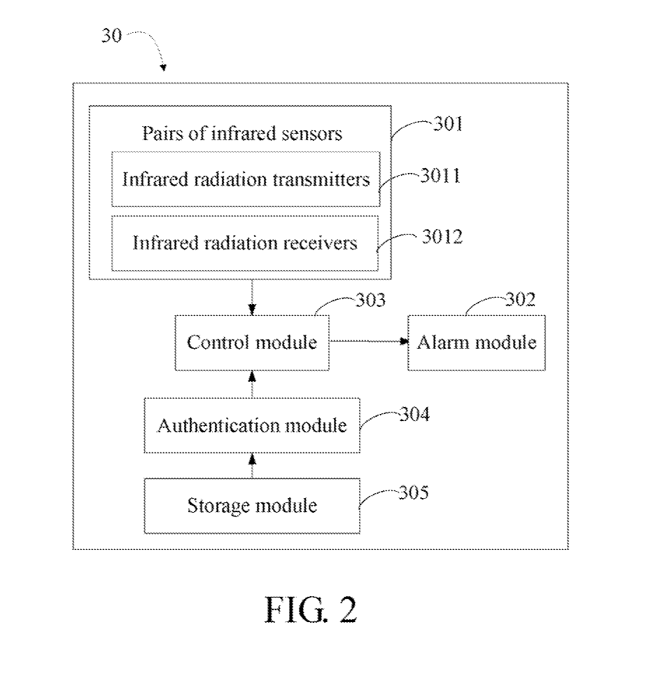

Referring to FIGS. 1-2, an exemplary embodiment of a device 1 is illustrated. The device 1, typically a safe-deposit box, includes an exterior casing 10, an interior casing 20 received in the exterior casing 10, and an alarm system 30. The exterior casing 10 and the interior casing 20 may each be rectangular and hollow, and made of metal or metallic material. The shape and material of the exterior casing 10 and the interior casing 20 are not limited, and can be varied according to need. The exterior casing 10 and the interior casing 20 cooperatively form a space 11 therebetween for receiving the alarm system 30.

Referring also to FIG. 2, in the embodiment, the alarm system 30 is based on infrared detection, and includes a number of pairs of infrared sensors 301 (only one pair shown in FIG. 2), an alarm module 302, and a control module 303.

Each pair of infrared sensors 301 includes an infrared radiation transmitter 3011 to emit infrared rays and an infrared radiation receiver 3012 to receive the infrared rays. In the embodiment, the infrared radiation transmitters 3011 are uniformly arranged at an inner surface 101 of the exterior casing 10, and each corresponding infrared radiation receiver 3012 is arranged at an outer surface 201 of the interior casing 20. Thus, the space 11 can be filled with infrared rays emitted by the infrared radiation transmitters 3011. The arrangement of the infrared radiation transmitters 3011 and the infrared radiation receivers 3012 is not limited and can be varied according to need, provided only that each infrared radiation receiver 3012 is configured to be able to receive the infrared rays radiating from a particular corresponding infrared radiation transmitter 3011.

The control module 303 is connected to each of the infrared radiation receivers 3012 to detect any signal generated by an infrared radiation receiver 3012. If it is detected that at least one infrared radiation receiver 3012 has ceased to receive infrared rays, the control module 303 actuates the alarm module 302 to generate a first alarm. In the embodiment, the first alarm generated by the alarm module 302 is a continuous audible signal such that authorized users of the device 1 in certain areas can be alerted by the first alarm and further monitor the security of the device 1. In the above-described structure, the alarm system 30 is completely protected by the exterior casing 10 of the device 1 and cannot be accessed by others. Thus, the device 1 can effectively detect movement within the device 1 and provide the first alarm upon such detection.

In the embodiment, the alarm system 30 further includes an authentication module 304 configured to determine an authorization status of an individual. The control module 303 further controls the alarm module 302 to cease the continuation of the first alarm when an individual is determined by the authentication module 304 to be authorized. In the embodiment, the authentication module 304 is arranged at or near an interior door 200, which forms a part of the interior casing 20. For example, the authentication module 304 can be arranged in the interior door 200.

In the embodiment, the authentication module 304 is a fingerprint reader. In this case, the alarm system 30 further includes a storage module 305 to store at least one set of reference fingerprint data corresponding to at least one authorized user of the device 1. The fingerprint reader reads the fingerprint of an individual's finger placed on the fingerprint reader to obtain corresponding fingerprint data, compares the read fingerprint data with the set(s) of reference fingerprint data stored in the storage module 305, and determines that the individual is authorized if the read fingerprint data matches any one of the set(s) of reference fingerprint data stored in the storage module 305.

In the embodiment, the control module 303 is further configured to allow the interior door 200 to be opened when the individual is determined to be authorized. While the interior door 200 is open, the control module 303 counts the time that the interior door 200 has been open for, and controls the alarm module 302 to generate a second alarm when the period that the interior door 200 has been open exceeds a predetermined threshold time. In the embodiment, the second alarm generated by the alarm module 302 is also an audible signal. The sound of the second alarm is different from that of the first alarm, and reminds the individual to close the interior door 200.

In the embodiment, an authorized user of the device 1 can enter the device 1 from an exterior door 100, which forms a part of the exterior casing 10. In this case, the authentication module 304 may instead be arranged at or near the exterior door 100, such that the exterior door 100 can be opened when an individual is determined by the authentication module 304 to be authorized. For example, the authentication module 304 can be arranged in the exterior door 100. While the exterior door 100 is open, the control module 303 counts the time that the exterior door 100 has been open for, and controls the alarm module 302 to generate the second alarm when the period that the exterior door 100 has been open exceeds a predetermined threshold time.

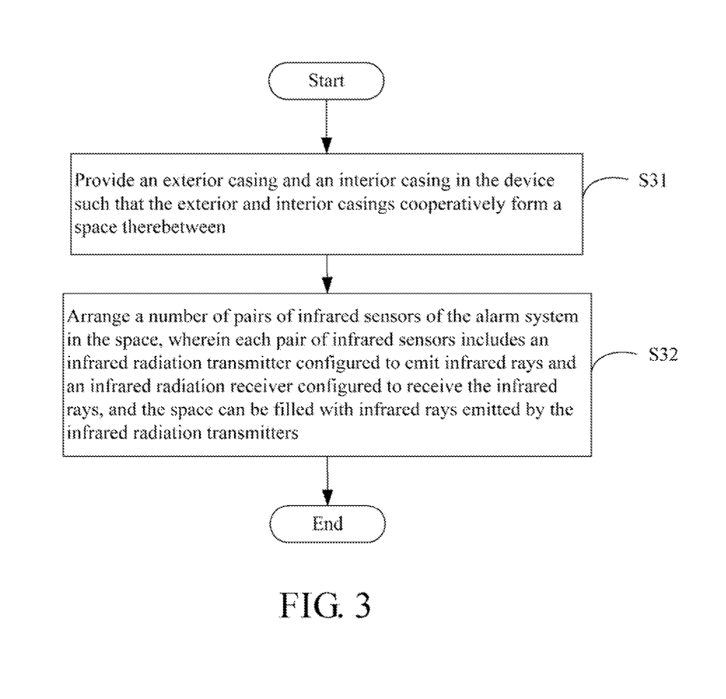

FIG. 3 is a flowchart of a method for installing the alarm system 30 to the device 1, according to an exemplary embodiment.

In step S31, the exterior casing 10 and the interior casing 20 are provided in the device 1 to cooperatively form the space 11 therebetween.

In step S32, a number of pairs of infrared sensors 301 of the alarm system 30 are arranged in the space 11, thereby allowing the space 11 to be filled with infrared rays. In the embodiment, the infrared radiation transmitters 3011 are uniformly arranged at the inner surface 101 of the exterior casing 10, and each corresponding infrared radiation receiver 3012 is arranged at the outer surface 201 of the interior casing 20.

Although the present disclosure has been specifically described on the basis of the exemplary embodiments thereof, the disclosure is not to be construed as being limited thereto. Various changes or modifications may be made to the embodiments without departing from the scope and spirit of the disclosure.

What is claimed is:

1. A device having an alarm system based on infrared detection, comprising:
an exterior casing;
an interior casing located in the exterior casing; and
an alarm system received in a space cooperatively formed by the exterior casing and the interior casing, the alarm system configured to detect transgression into the space, and comprising:
a plurality of pairs of infrared sensors, each pair of infrared sensors comprising:
an infrared radiation transmitter configured to emit infrared rays, whereby the space is fillable with infrared rays emitted by all the infrared radiation transmitters; and
an infrared radiation receiver configured to receive the infrared rays from the infrared radiation transmitter;
an alarm module; and
a control module connected to each of the infrared radiation receivers, and configured to detect any signal generated by an infrared radiation receiver, and actuate the alarm module to generate a first alarm when at least one infrared radiation receiver has ceased to receive infrared rays.

2. The device as described in claim 1, wherein the infrared radiation transmitters are uniformly arranged at an inner surface of the exterior casing, and each corresponding infrared radiation receiver is arranged at an outer surface of the interior casing.

3. The device as described in claim 1, further comprising an authentication module, wherein the authentication module is configured to determine whether an individual is authorized, and the control module is further configured to control the alarm module to cease the first alarm when the individual is determined by the authentication module to be authorized.

4. The device as described in claim 3, wherein the authentication module comprises a fingerprint reader, and the fingerprint reader is configured to read the fingerprint of an individual's finger placed on the fingerprint reader to obtain corresponding fingerprint data, compare the read fingerprint data with at least one set of reference fingerprint data stored in the alarm system, and determine the individual to be authorized on condition that the read fingerprint data matches any one of the at least one set of reference fingerprint data.

5. The device as described in claim 3, wherein the exterior casing comprises a door, the control module is further configured to allow the door to be opened when the individual is determined to be authorized, and while the door is open, the control module is further configured to count the time the door has been open for, and control the alarm module to generate a second alarm when the period that the door has been open exceeds a predetermined threshold time.

6. The device as described in claim 3, wherein the interior casing comprises a door, the control module is further configured to allow the door to be opened when the individual is determined to be authorized, and while the door is open, the control module is further configured to count the time the door has been open for, and controls the alarm module to generate a second alarm when the period that the door has been open exceeds a predetermined threshold time.

7. A method for installing an alarm system to a device, comprising:
providing an exterior casing and an interior casing in the device such that the exterior and interior casings cooperatively form a space therebetween; and
arranging a plurality of pairs of infrared sensors of the alarm system in the space, each pair of infrared sensors comprising an infrared radiation transmitter configured to emit infrared rays and an infrared radiation receiver configured to receive the infrared rays, whereby the space is fillable with infrared rays emitted by the infrared radiation transmitters.

8. The method as described in claim 7, wherein the infrared radiation transmitters are uniformly arranged at an inner surface of the exterior casing, and each corresponding infrared radiation receiver is arranged at an outer surface of the interior casing.
